(19) United States
(12) Patent Application Publication
(10) Pub. No.: US 2015/0022564 A1
(43) Pub. Date: Jan. 22, 2015

(54) Display Device And Method

(71) Applicant: Lenovo (Beijing) Co., Ltd., Haidian District, Beijing (CN)

(72) Inventors: Zhenhua Zhang, Haidian District (CN); Ke Shang, Haidian District (CN)

(73) Assignee: LENOVO (BEIJING) CO., LTD., Haidian District, Beijing (CN)

(21) Appl. No.: 14/348,352

(22) PCT Filed: Mar. 25, 2013
(86) PCT No.: PCT/CN2013/073111

§ 371 Date: Mar. 28, 2014

(30) Foreign Application Priority Data
Mar. 26, 2012 (CN) 201210082626.2

(51) Int. Cl. G09G 5/02; G09G 5/10

(52) U.S. Cl. CPC G09G 5/02; G09G 5/10
USPC 345/690

(57) ABSTRACT

A display device includes a first display module for receiving image data and displaying an image according to the received image data; a second display module disposed on the first display module and for receiving image data and displaying an image according to the received image data; and a control module for controlling the first display module and the second display module. The control module controls the second display module and makes the second display module modulated into a visible light band transmission state or a visible light band reflection state. When the second display module is modulated into the visible light band transmission state, the second display module is transparent to the visible light and penetrates the image displayed on the first display module.

### BACKGROUND

The present disclosure relates to a new display technology, and in particular to a display device being capable of performing both a reflective display and a non-reflective display and its corresponding method.

Human eye's perception to the display color of the display device is influenced by the ambient light to a great extent. For a display of a specific image, as the ambient light intensity increases, human eye's perception to the display picture may be: intensity is decreased, saturation is reduced and color is not enough rich and natural.

At present, a screen brightness automatic adjustment function is configured in some display devices. An ambient light sensor (ALS) is utilized to sense the ambient light intensity and the screen brightness is automatically adjusted within certain limits according to the ambient light intensity, so as to improve visibility of the display picture on the display device to some extent. However, the existing screen brightness automatic adjustment function of the display device is very limited. In a case of a very high ambient light intensity, the display picture of the display device that has been adjusted by the existing screen brightness automatic adjustment function is difficult to have a good brightness and a color expression capability.

In addition, in a case of a very high ambient light intensity, adjusting the brightness of the display device through the existing screen brightness automatic adjustment function is actually to increase brightness of the display device, which correspondingly also increases power consumption of the display device. However, it has been known that the effect of such adjustment is undesirable.

Therefore, it is expected to provide a display device and display method for providing an ideal picture display both indoors and outdoors.

### SUMMARY

In view of the above problem, the present disclosure is made. One purpose of the present disclosure is to provide a display device and a corresponding display method for displaying by switchably utilizing two different display modules in different ambient light intensities, so that a good color expression capability can be obtained in various ambient light intensities and a good display effect is realized.

According to one aspect of the present disclosure, provided is a display device, comprising: a first display module configured for receiving image data and displaying an image according to the received image data; a second display module disposed on the first display module and configured for receiving image data and displaying an image according to the received image data; and a control module configured for controlling the first display module and the second display module, wherein the control module controls the second display module, such that the second display module is modulated into a visible light band transmission state or a visible light band reflection state, and the second display module is transparent to the visible light and penetrates the image displayed on the first display module when the second display module is modulated into the visible light band transmission state.

Preferably, in the display device, the control module controls a supply of the image data to the first display module and controls the first display module to display the image according to the received image data when the second display module is modulated into the visible light band transmission state.

Preferably, in the display device, the control module further switches off a supply of the image data to the second display module when the second display module is modulated into the visible light band transmission state.

Preferably, in the display device, the control module controls a supply of the image data to the second display module and controls the second display module to display the image according to the received image data when the second display module is modulated into the visible light band reflection state.

Preferably, in the display device, the control module further switches off power supply to the first display module or switches off a supply of the image data to the first display module and makes the first display module be in a standby state when the second display module is modulated into the visible light band reflection state.

Preferably, the display device further comprises a light detection module configured for detecting an ambient light intensity around the display device, wherein the second display module is modulated into the visible light band transmission state when the detected ambient light intensity is lower than a predetermined light intensity threshold; and the second display module is modulated into the visible light band reflection state when the detected ambient light intensity is higher than the predetermined light intensity threshold.

According to another aspect of the present disclosure, provided is a display method for a display device, comprising a first display module and a second display module which is disposed on the first display module and can be modulated into a visible light band transmission state or a visible light band reflection state. The display method comprises: obtaining a control signal; displaying an image by the first display module according to input image data and the second display module being transparent to the visible light and penetrating the image displayed on the first display module when the control signal indicates that the second display module is required to be modulated into the visible light band transmission state.

Preferably, in the display method, the input image data is supplied to the first display module and a supply of the input image data to the second display module is switched off when the second display module is modulated into the visible light band transmission state.

Preferably, the display method further comprises: supplying the input image data to the second display module and displaying the image by the second display module according to the input image data when the second display module is modulated into the visible light band reflection state.

Preferably, the display method further comprises: switching off power supply to the first display module, or switching off a supply of the input image data to the first display module and making the first display module be in a standby state when the second display module is modulated into the visible light band reflection state.

Preferably, the display method further comprises: detecting ambient light intensity around the display device; generating the control signal and making the control signal indicate that the second display module is required to be modulated into the visible light band transmission state when the detected ambient light intensity is lower than a predetermined light intensity threshold, and generating the control signal and making the control signal indicate that the second display module is required to be modulated into the visible light band reflection state when the detected ambient light intensity is higher than the predetermined light intensity threshold.

Preferably, in the display device and the display method, the second display module is a photonic crystal display module.

Preferably, in the display device and the display method, the first display module is one of the following: a liquid crystal display module, a light emitting diode display module, an organic light emitting display module, a plasma display module, a CRT display module and a digital shutter display module.

According to the display method and the display device of the present disclosure, the second display module is utilized to perform a reflective display when the ambient light intensity is high, which can obtain a good color expression capability, realize a good display effect and at the same time avoid the need for gradually increasing the display brightness of the first display module. Further, the power consumption needed for the display device is also reduced. In particular, the power consumption needed for performing the reflective display utilizing the second display module is also smaller than the power consumption needed for performing display utilizing the first display module.

### BRIEF DESCRIPTION OF THE DRAWINGS

The above and other purposes, features and advantages of the present disclosure will become clearer through a detailed description of the embodiments of the present disclosure in combination with the accompanying drawings, wherein:

FIG. 1 is a schematic diagram illustrating a photonic crystal unit being modulated into a reflection or transmission state;

FIG. 2 is a schematic diagram illustrating one display pixel being composed of a plurality of photonic crystal units;

FIG. 3 is a schematic diagram illustrating a display mode according to an embodiment of the present disclosure;

FIG. 4 is a schematic block diagram illustrating a display device according to an embodiment of the present disclosure; and

FIG. 5 is a schematic diagram illustrating a display method according to an embodiment of the present disclosure.

### DETAILED DESCRIPTION

Below will be a description of a display device and its display method according to the embodiments of the present disclosure by referring to the accompanying drawings. It should be understood that the embodiments described herein are just for illustration, and should not be construed as limiting the scope of the present disclosure.

First, a display application of photonic crystals is simply specified in combination with FIG. 1.

The photonic crystals show a periodic dielectric structure having photonic bandgaps, and thus are also referred to as photonic bandgap materials. Dielectric materials with different dielectric constants are used to form a periodic structure, when a light wave is spread in the periodic structure, it will be modulated due to Bragg scattering to form a band structure, such band structure is called as photonic bands, and bandgaps appearing among the photonic bands are called as photonic bandgaps. Light waves with their frequencies falling into the photonic bandgaps are forbidden to be spread. In other words, the photonic crystals take on a characteristic of “band rejection” to light rays.

On one aspect, the light waves with their frequencies falling into the photonic bandgaps are forbidden to be spread in the photonic crystals. At this time, the photonic crystals behave to take on a complete reflection state for the light waves with their frequencies falling into the photonic bandgaps.

On the other aspect, the light waves with their frequencies not falling into the photonic bandgaps are allowed to be spread in the photonic crystals. At this time, the photonic crystals behave to take on a complete transmission state to the light waves with their frequencies falling into the photonic bandgaps.

The frequency range of the photonic bandgaps of the photonic crystals can be adjusted by adjusting electric fields applied to the photonic crystals, that is, the frequency range of the light waves that are rejected by the photonic crystals or forbidden by the photonic crystals to be spread in the photonic crystals can be adjusted.

FIG. 1 shows a photonic crystal unit being composed of the photonic crystals. The spread effect presented by the photonic crystal unit to a visible light can be adjusted by adjusting the electric fields applied to the photonic crystal unit, for example, the photonic crystal unit can be made to behave reflection to the visible light (i.e., rejecting the visible light or forbidding the visible light to be spread in the photonic crystals), or the photonic crystal unit can be made to behave transparency/transmission to the visible light (i.e., reflecting invisible light within certain frequency (wave length range), rejecting the invisible light within the certain frequency (wave length range) or forbidding the invisible light within the certain frequency (wave length range) to be spread in the photonic crystals).

As shown in (a) of FIG. 1, the photonic crystal unit behaves reflection to the visible light. As shown in (b) of FIG. 1, the photonic crystal unit behaves transparency to the visible light.

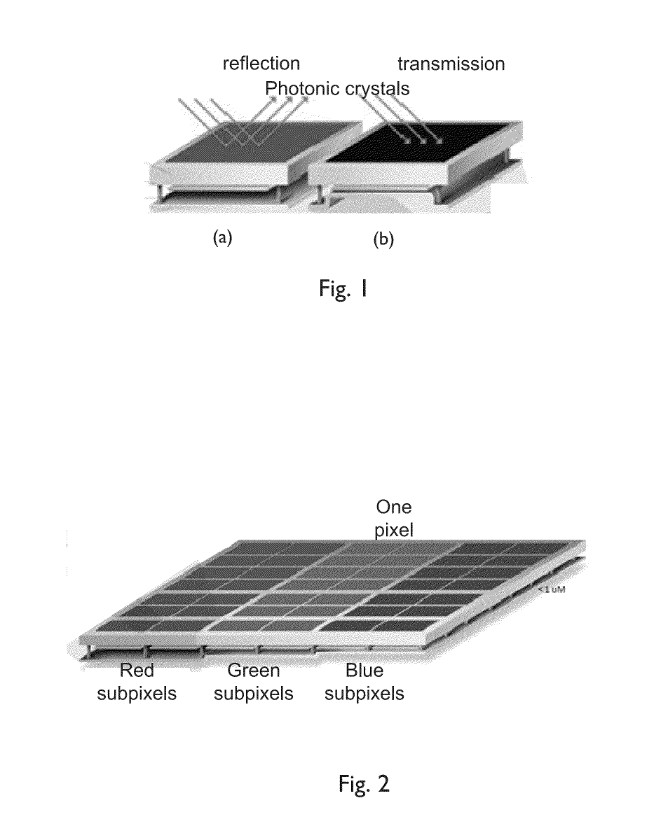

FIG. 2 shows one display pixel being composed of a plurality of photonic crystal units, wherein the size of the display pixel and the size of each of photonic crystal units are exaggerated. Of course, one display pixel can be composed of photonic crystal units with other number. FIG. 2 is just for illustration, and the protection scope of the present disclosure is not limited to specific examples of FIG. 2. In addition, the display pixel may not be composed of color subpixels instead of black and white subpixels.

Based on the cases as shown in FIGS. 1 and 2, provided is a display mode according to the embodiment of the present disclosure. The display mode according to the embodiment of the present disclosure utilizes a combination of two different types of display modules to provide a good display effect in two environments of both indoors (the ambient light being relatively weak) and outdoors (the ambient light being relatively strong). Therefore, the two different types of display modules comprise a first display module and a second display module.

The first display module may be a display module existing in the prior art that can provide a good display effect in the environment of indoors (the ambient light being relatively weak), which may include but not limited to a liquid crystal display module, a light emitting diode display module, an organic light emitting display module, a plasma display module, a CRT display module and a digital shutter display module. Further, the first display module may further be a display module to be developed in future that can provide a good display effect in the environment of indoors (the ambient light being relatively weak). The present disclosure shall not be limited to the specially used type of the first display module.

The second display module is disposed on the first display module, for example, the second display module may be adjacently disposed on the first display module, or there may be gaps or other transparent medium existing between the first display module and the second display module.

The second display module may be modulated into a visible light band transmission state or a visible light band reflection state. The second display module is transparent to the visible light and penetrates an image displayed on the first display module when the second display module is modulated into the visible light band transmission state. On the other hand, the second display module takes on a reflection state to the visible light when the second display module is modulated into the visible light band reflection state, and in such a case, the second display module can be utilized to display the image, in other words, in this case, the second display module can be utilized to perform a reflective display.

The second display module may be for example a photonic crystal display module, and changes bandgap (band rejection) characteristic of the photonic crystals through adjusting the electric field applied to the photonic crystal unit.

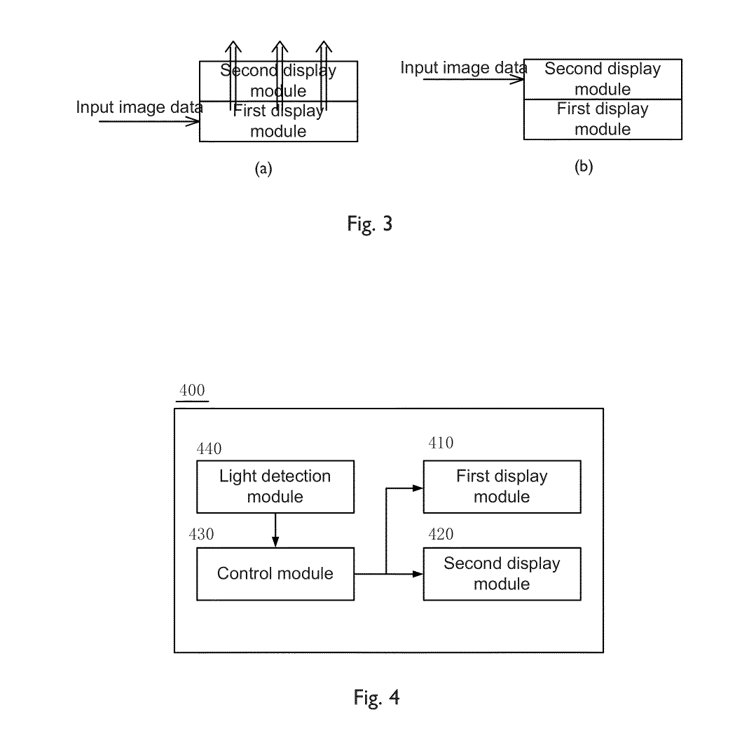

As shown in (a) of FIG. 3, the second display module is modulated into the visible light band transmission state, and can penetrate the image displayed on the first display module. At this time, the first display module is utilized to display the image, and the second display module is equivalent to a transparent layer disposed on the first display module.

As shown in (b) of FIG. 3, the second display module is modulated into the visible light band reflection state, the second display module takes on a reflection state to the visible light, the first display module is invisible from the second display module, and even if the image is displayed on the first display module, the image displayed on the first display module is also invisible from the second display module. In such a case, the second display module is utilized to display the image. At this time, as a reflective-type display module, the second display module per se utilizes the ambient light to perform a reflective display. As known, a common reflective-type display module has a display effect worse than a backlight-type or self-luminous display module when the ambient light intensity is low.

Next, a display device 400 according to the embodiment of the present disclosure will be described by referring to FIG. 4.

As shown in FIG. 4, the display device 400 comprises: a first display module 410, a second display module 420, and a control module 430.

The first display module 410 receives input image data and displays an image according to the received input image data. The first display module 410 can be for example a liquid crystal display module, a light emitting diode display module, an organic light emitting display module, a plasma display module, a CRT display module and a digital shutter display module. In general, the first display module 410 has a good color expression capability and can provide a good display effect when the ambient light intensity is not high; however, when the ambient light intensity is high, the first display module 410 cannot provide a good display effect even if the display brightness of the first display module is increased.

The second display module 420 is disposed on the first display module. For example, the second display module may be adjacently disposes on the first display module, or there may be gaps or other transparent medium existing between the first display module and the second display module.

The second display module 420 receives the input image data and displays an image according to the received input image data. For example, the second display module is a photonic crystal display module.

The control module 430 controls the first display module and the second display module.

The control module 430 may control whether to utilize the first display module 410 or utilize the second display module 420 to display, and may control the second display module 420, such that the second display module 420 can be modulated into a visible band transmission state or a visible light band reflection state.

In addition, the control module 430 may further control whether or not to supply the input image data to the first display module 410, whether or not to supply the input image data to the second display module 420, and whether or not to switch off the power supply to the first display module 410 and the like.

The control module 430 may receive an operation from the user and make a corresponding control based on the operation of the user.

For example, the control module 430 may receive an instruction of the user, which indicates that the second display module 420 is required to be modulated into the visible light band transmission state. In such a case, the control module 430 controls the second display module 420, such that the second display module 420 is modulated into the visible light band transmission state, and controls the first display module 410 to display the image according to the received input image data. Advantageously, the control module 430 further controls a supply of the input image data to the first display module 410 and switches off the supply of the input image data to the second display module 420.

On the other hand, the control module 430 may receive the instruction of the user, which indicates that the second display module 420 is required to be modulated into the visible light band reflection state. In such a case, the control module 430 controls the second display module 420, such that the second display module 420 is modulated into the visible light band reflection state, and controls the second display module 420 to display the image according to the received input image data. Advantageously, the control module 430 further controls a supply of the input image data to the second display module 420 and switches off the supply of the input image data to the first display module 410. More advantageously, the control module 430 further controls to make the first display module 410 be in a standby state or switches off the power supply to the first display module 410.

The operation of the user may be that the user selects on a specific user interface to utilize which display module to display, or may be that the user presses a hardware switch to indicate to utilize which display module to display, or may be that the user performs a specific operation gesture and the like. The present disclosure is not limited to a specific operation action of the user.

In addition, the display device may further comprise a light detection module 440 configured for detecting the ambient light intensity around the display device.

The light detection module 440 may directly supply the detected ambient light intensity to the control module 430, or may determine a control signal according to the detected ambient light intensity and provide the control signal to the control module 430.

In a case that the light detection module 440 directly provides the detected ambient light intensity to the control module 430, the control module 430 judges whether the detected ambient light intensity is lower than a predetermined light intensity threshold, and if the detected ambient light intensity is lower than the predetermined light intensity threshold, then it is determined that the second display module 420 is required to be modulated into the visible band transmission state and performs a corresponding control; otherwise, it is determined that the second display module 420 is required to be modulated into the visible light band reflection state and performs a corresponding control.

In a case that the light detection module 440 determines the control signal according to the detected ambient light intensity, the light detection module 440 judges whether the detected ambient light intensity is lower than a predetermined light intensity threshold, and if the detected ambient light intensity is lower than the predetermined light intensity threshold, then it is determined that the control signal is a control signal indicating that the second display module 420 is required to be modulated into the visible band transmission state; otherwise, it is determined that the control signal is a control signal indicating that the second display module 420 is required to be modulated into the visible light band reflection state.

In the display device 400, the above two control modes may be used in a combined manner. For example, it may be made that a priority of the instruction generated by the user's operation is higher than a priority of the control signal of the light detection module.

As described above, the display brightness of the first display module 410 is avoided from being gradually increased through utilizing the second display module 420 to perform a reflective display when the ambient light intensity is relatively high, which not only can realize a better display effect but also avoid an increase of power consumption of the display device. In fact, the power consumption needed for the second display module 420 to perform a reflective display is smaller than the power consumption needed for a normal display of the first display module 410 (i.e., when the ambient light intensity is relatively low or not high).

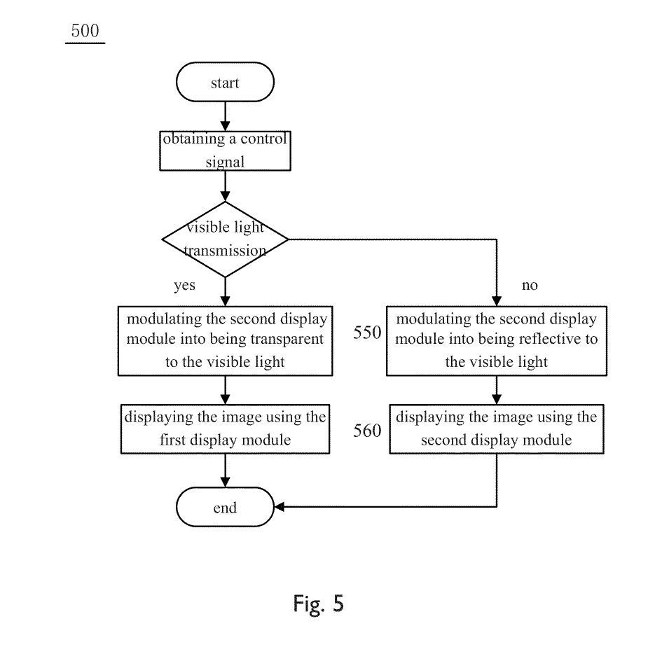

Next, a display method 500 according to the embodiment of the present disclosure is described by referring to FIG. 5. The display method 500 is applicable to the display device 400 comprising the first display module 410 and the second display module 420 according to the embodiment of the present disclosure. The second display module 420 is disposed on the first display module 410 and can be modulated into a visible light band transmission state or a visible light band reflection state. The first display module 410 may be one of the following: a liquid crystal display module, a light emitting diode display module, an organic light emitting display module, a plasma display module, a CRT display module and a digital shutter display module. The second display module 420 may be a photonic crystal display module.

The display method 500 according to the embodiment of the present disclosure starts at step S501.

First, at step S510, a control signal is obtained. As described above, the control signal may be a control signal generated according to an instruction from the operation of the user or may be a control signal generated according to the obtained ambient light intensity based on a predetermined condition.

The operation of the user may be that the user selects on a specific user interface to utilize which display module to display, or may be that the user presses a hardware switch to indicate to utilize which display module to display, or may be that the user performs a specific operation gesture and the like. The present disclosure is not limited to a specific operation action of the user.

In a case that the control signal is generated based on the predetermined condition according to the obtained ambient light intensity, the display method according to the embodiment of the present disclosure advantageously further comprises the following steps prior to the step S510: detecting the ambient light intensity around the display device; and generating the control signal and making the control signal indicate that the second display module 420 is required to be modulated into the visible light band transmission state when the detected ambient light intensity is lower a predetermined light intensity threshold while generating the control signal and making the control signal indicate that the second display module 420 is required to be modulated into the visible light band reflection state when the detected ambient light intensity is higher the predetermined light intensity threshold.

Then, at step S520, it is judged whether the control signal indicates that the second display module 420 is required to be modulated into the visible light band transmission state.

If it is judged at step S520 that the control signal indicates that the second display module 420 is required to be modulated into the visible light band transmission state, then the display method of the embodiment of the present disclosure moves to step S530.

At step S530, the second display module 420 is modulated into the visible light band transmission state, i.e., being transparent to the visible light band. At step S540, the first display module 410 is utilized to display the image according to the input image data. In such a case, the second display module 420 is transparent to the visible light and penetrates the image displayed on the first display module 410.

Advantageously, in such a case, a supply of the input image data to the second display module 420 is switched off.

On the other hand, if it is judged at step S520 that the control signal indicates that the second display module 420 is required to be modulated into the visible light band reflection state, then the display method of the embodiment of the present disclosure moves to step S550.

At step S550, the second display module 420 is modulated into the visible light band reflection state, i.e., being transparent to the invisible light within specific frequency (band length range) while taking on a complete reflection state to the visible light band. At step S560, the second display module 420 is utilized to display the image according to the input image data.

Advantageously, in such a case, the supply of the input image data to the first display module 410 is switched off. More advantageously, it is controlled to make the first display module 410 be in the standby state or power supply to the first display module 410 is switched off.

As described above, the second display module 420 is utilized to perform a reflective display, which not only can realize a better display effect but also avoid an increase of power consumption of the display device 400. In fact, the power consumption needed for the second display module 420 to perform a reflective display is smaller than the power consumption needed for a normal display of the first display module 410.

Below will be a brief description of an application scene according to the display device and the display method of the embodiment of the present disclosure.

1) The display device is at present in a state of using the first display module 410 to display the image. In such a case, the second display module 420 is modulated into a visible light band transmission state, and a supply of the input image data to the second display module 420 is switched off.

2) The ambient light intensity around the display device 400 changes, and the detected ambient light intensity is determined to be higher than the predetermined light intensity threshold, and thus it is determined that it is needed to modulate the second display module 420 into the visible light band reflection state and utilize the second display module 420 to display the image.

3) According to the determination result in 2), the user is prompted that it is needed to modulate the second display module 420 into the visible light band reflection state, and the user is inquired whether to agree to switch. It shall be known that such prompt and inquiry are optional but not essential.

4) According to the determination result in 2) (in a case of not performing 3)), or according to the instruction that the user agrees to switch (in a case of performing 3)), it is controlled to modulate the second display module 420 into the visible light band reflection state, the input image data is supplied to the second display module 420, the supply of the input image data to the first display module 410 is switched off, and the first display module 410 is made to be in the standby state or the power supply to the first display module 410 is switched off. In such a case, the second display module 420 is utilized to perform a reflective display.

5) An instruction of the user's operation is received. The instruction indicates that the second display module 420 is required to be modulated into the visible light band transmission state.

6) If the detected ambient light intensity is still determined as being higher than the predetermined light intensity, then the user is inquired whether it is determined to modulate the second display module 420 into the visible light band transmission state. It should be known that such inquiry is optional but not essential.

7) According to the determination result in 5) (in a case of not performing 6)), or according to the user's instruction of determining to switch (in a case of performing 6)), the second display module 420 is modulated into the visible light band transmission state, the input image data is supplied to the first display module 410, the first display module 410 is utilized to display the image according to the input image data, and the supply of the input image data to the second display module 420 is switched off.

The above is a description by modulating the second display module into the visible light band reflection state. However, it should be understood that in actual implementations, one display pixel of the second display module 420 may be composed of red subpixels, blue subpixels and green subpixels (as shown in FIG. 2) or may be composed of red subpixels, blue subpixels, green subpixels and yellow subpixels (not shown in the figure), or respective subpixels in one display pixel may not be divided into color subpixels with a specific color.

It should be understood that, in a case that one display pixel is composed of red subpixels, blue subpixels and green subpixels, when the second display module 420 is modulated into being reflective to the visible light band, in particular, the red subpixels are modulated into being reflective to the red visible light band and the green subpixels are modulated into being reflective to the green visible light band, and the blue subpixels are modulated into being reflective to the blue visible light band. Thus, a mixed color display is realized by the red subpixels, the blue subpixels and the green subpixels.

Further, in such a case, the red subpixels, the blue subpixels and the green subpixels can be modulated according to certain sequential control. For example, during a first period of time, the red subpixels are modulated into being reflective to the red visible light band and the blue subpixels and the green subpixels are turned off; during a second period of time after the first period of time, the blue subpixels are modulated into being reflective to the blue visible light band, and the red subpixels and the green subpixels are turned off; during a third period after the second period of time, the green subpixels are modulated into being reflective to the green visible light band, and the blue subpixel and the red subpixel are turned off, wherein said being turned off may be a non-operation state of the subpixels. Thus, a mixed color display can be realized by using human eye's characteristics.

In addition, in a case that one display pixel is composed of subpixels being not divided into specific colors, the second display module 420 is modulated into being reflective to the visible light band. In particular, respective subpixels are modulated according to certain sequential control. For example, during a first period of time, the respective subpixels are modulated into being reflective to the red visible light band; during a second period of time after the first period of time, the respective subpixels are modulated into being reflective to the blue visible light band; during a third period after the second period of time, the respective subpixels are modulated into being reflective to the green visible light band. Thus, a mixed color display can be realized by using human eye's characteristics.

For display of primary colors with more colors, the display pixel in the second display module can be modulated in a similar manner, details omitted.

According to the display method and display device of the present disclosure, two different types of display modules are utilized to provide a good display effect in various ambient light intensities and at the same time to reduce power consumption of the display device.

According to the descriptions herein, those ordinary skilled in the art can think of these or similar implementations or configurations of the present disclosure.

Although some embodiments of the present disclosure are described herein by referring to the accompanying figures, it should be understood that the embodiments are just for illustration rather than for limitation. Those skilled in the art shall understand that various changes in forms and details can be made to these illustrative embodiments without departing from the scope and spirit of the present disclosure defined in the claims and their equivalents.

1. A display device, comprising:
a first display module configured to receive image data and to display an image according to the received image data;
a second display module disposed on the first display module and configured to receive image data and displaying an image according to the received image data; and
a control module configured to control the first display module and the second display module,
wherein the control module controls the second display module, such that the second display module is modulated into a visible light band transmission state or a visible light band reflection state,
the second display module is transparent to the visible light and penetrates the image displayed on the first display module when the second display module is modulated into the visible light band transmission state.

2. The display device as claimed in claim 1, wherein the control module controls a supply of the image data to the first display module and controls the first display module to display the image according to the received image data when the second display module is modulated into the visible light band transmission state.

3. The display device as claimed in claim 2, wherein the control module further switches off a supply of the image data to the second display module.

4. The display device as claimed in claim 1, wherein the control module controls a supply of the image data to the second display module and controls the second display module to display the image according to the received image data when the second display module is modulated into the visible light band reflection state.

5. The display device as claimed in claim 4, wherein the control module switches off power supply to the first display module, or switches off a supply of the image data to the first display module and makes the first display module be in a standby state.

6. The display device as claimed in claim 1, further comprising a light detection module configured to detect ambient light intensity around the display device,
wherein the second display module is modulated into the visible light band transmission state when the detected ambient light intensity is lower than a predetermined light intensity threshold; and
the second display module is modulated into the visible light band reflection state when the detected ambient light intensity is higher than the predetermined light intensity threshold.

7. The display device as claimed in claim 1, wherein the second display module is a photonic crystal display module.

8. The display device as claimed in claim 1, wherein the first display module is one of the following: a liquid crystal display module, a light emitting diode display module, an organic light emitting display module, a plasma display module, a CRT display module and a digital shutter display module.

9. A display method for a display device comprising a first display module and a second display module which is disposed on the first display module and can be modulated into a visible light band transmission state or a visible light band reflection state, comprising:
obtaining a control signal;
displaying an image by the first display module according to input image data, and the second display module being transparent to the visible light and penetrating the image displayed on the first display module, when the control signal indicates that the second display module is required to be modulated into the visible light band transmission state.

10. The display method as claimed in claim 9, wherein the input image data is supplied to the first display module and a supply of the input image data to the second display module is switched off when the second display module is modulated into the visible light band transmission state.

11. The display method as claimed in claim 9, further comprising supplying the input image data to the second display module and displaying the image by the second display module according to the input image data when the second display module is modulated into the visible light band reflection state.

12. The display method as claimed in claim 11, further comprising:
switching off power supply to the first display module, or switching off a supply of the input image data to the first display module and making the first display module be in a standby state.

13. The display method as claimed in claim 9, further comprising:
detecting ambient light intensity around the display device; and
generating the control signal and making the control signal indicate that the second display module is required to be modulated into the visible light band transmission state when the detected ambient light intensity is lower than a predetermined light intensity threshold, and generating the control signal and making the control signal indicate that the second display module is required to be modulated into the visible light band reflection state when the detected ambient light intensity is higher than the predetermined light intensity threshold.

14. The display method as claimed in claim 9, wherein the second display module is a photonic crystal display module.

15. The display method as claimed in claim 9, wherein the first display module is one of the following: a liquid crystal display module, a light emitting diode display module, an organic light emitting display module, a plasma display module, a CRT display module and a digital shutter display module.
